(19) United States
(12) Patent Application Publication
(10) Pub. No.: US 2025/0136776 A1
(43) Pub. Date: May 1, 2025

(54) METHOD FOR PRODUCING POROUS ARTICLES FROM ULTRA HIGH MOLECULAR WEIGHT POLYETHYLENE

(71) Applicant: W. L. Gore & Associates, Inc., Newark, DE (US)

(72) Inventors: Orlando Collazo, Dover, DE (US); Spencer D. Jackman, Flagstaff, AZ (US); Guy A. Sbriglia, Christiana, PA (US); Jason J. Strid, Elkton, MD (US)

(21) Appl. No.: 18/837,948

(22) PCT Filed: Feb. 13, 2023
(86) PCT No.: PCT/US2023/012897

§ 371 Date: Aug. 13, 2024

Related U.S. Application Data
(60) Provisional application No. 63/309,891, filed on Feb. 14, 2022.

(51) Int. Cl. C08J 9/22; C08J 5/18

(52) U.S. Cl. CPC C08J 9/22; C08J 5/18; C08J 2323/06

(57) ABSTRACT

Ultra high molecular weight polyethylene (UHMWPE) polymers that have an average molecular weight of at least 2,000,000 g/mol and an enthalpy of at least 190 J/g is provided. The UHMWPE polymer may include at least one comonomer. The UHMWPE poly mer is used to form a membrane, that, when expanded, has a node and fibril structure. The UHMWPE membrane has an endotherm of about 150° C. associated with the fibrils in the membrane. The membrane has a percent porosity of at least 60% and a bubble point of a bubble point of 138 kPa or less. Additionally, the UHMWPE membrane has a thickness less than 1 mm. An UHMWPE membrane may be formed by lubricating the UHMWPE poly mer, subjecting the lubricated poly mer to pressure at a temperature below the melting point of the UHMWPE poly mer to form a tape, and expanding the tape at a temperature both below and above the melting temperature of the UHMWPE polymer.

### CROSS-REFERENCE TO RELATED APPLICATION

This application is a national phase application of PCT Application No. PCT/US2023/012897, internationally filed on Feb. 13, 2023, which claims the benefit of Provisional Application No. 63/309,891, filed Feb. 14, 2022, which are incorporated herein by reference in their entireties for all purposes.

### FIELD OF THE INVENTION

The present disclosure relates generally to ultra high molecular weight polyethylene (UHMWPE) polymers, and more specifically, to a process for the formation of porous articles from a highly crystalline ultra high molecular weight polyethylene polymer.

### BACKGROUND OF THE INVENTION

Ultra high molecular weight polyethylene is well known in the art. Articles made from ultra high molecular weight polyethylene possess properties such as toughness, impact strength, abrasion resistance, low coefficient of friction, gamma resistance, and resistance to attack by solvents and corrosive chemicals. Because of the favorable attributes associated with ultra high molecular weight polyethylene, ultra high molecular weight polyethylene has been utilized in a variety of applications, such as load-bearing components of articulating joint prostheses, vibration dampener pads, hydraulic cylinders, sports equipment, including, but not limited to, skis, ski poles, goggle frames, protective helmets, climbing equipment, and in specialized applications in aerospace.

UHMWPE polymers can be processed by compression molding, ram extrusion, gel spinning, and sintering. However, some conventional processes have one or more undesirable feature or attribute, such as requiring high solvent levels, have a non-porous structure, and/or are costly or slow to process due to the high viscosity of the UHMWPE polymer. Thus, there exists a need in the art for a process for making an UHMWPE article that is processed above the melt temperature of the UHMWPE polymer, has high strength, has a microstructure of nodes and fibrils for ease of processing, and is highly porous.

### SUMMARY OF THE INVENTION

Provided herein are articles including a porous polyethylene membrane formed from ultra high molecular weight polyethylene (UHMWPE) polymers, and processes for the formation of porous articles from a highly crystalline ultra high molecular weight polyethylene polymer.
According to a first embodiment (“Embodiment 1”), provided is an article including: a porous polyethylene membrane formed from an ultra-high molecular weight polyethylene (UHMWPE) polymer having a molecular weight of at least 2,000,000 g/mol; and a melt enthalpy of at least 190 J/g; wherein the porous polyethylene membrane includes: a node and fibril microstructure having a structure of nodes interconnected by fibrils; a detectable first endotherm associated with the UHMWPE polymer ranging from 139° C. to 143° C.; a detectable second endotherm from 145° C. to 155° C. associated with the fibrils, and a bubble point of about 138 kPa or less, preferably 69 kPa or less, and more preferably 34.5 kPa or less.
Embodiment 2 is the article of Embodiment 1, wherein the porous polyethylene membrane has an ATEQ® airflow of at least 50 L/hr, preferably at least 500 L/hr, and more preferably at least 1000 L/hr at 1.2 kPa pressure over a surface area of 2.99 cm².
Embodiment 3 is the article of Embodiments 1 to 2, wherein the porous polyethylene membrane has a matrix tensile strength in the machine direction (MD) of at least 30 MPa.
Embodiment 4 is the article of Embodiments 1 to 3, wherein the porous polyethylene membrane has a matrix tensile strength in the transverse direction (TD) of least 4 MPa.
Embodiment 5 is the article of Embodiments 1 to 4, wherein the membrane is biaxially oriented.
Embodiment 6 is the article of Embodiments 1 to 5, wherein the ratio of the matrix tensile strength MD:TD is from about 0.1:1 to 1:0.1.
Embodiment 7 is the article of Embodiments 1 to 6, wherein the UHMWPE polymer has a molecular weight from 2,000,000 g/mol and 12,000,000 g/mol.
Embodiment 8 is the article of Embodiments 1 to 7, wherein the article is a sheet, membrane, tape, fiber, tube, bead or a three-dimensional self-supporting structure.
Embodiment 9 is the article of Embodiments 1 to 8, wherein the porous membrane has a porosity of at least 60%.
Embodiment 10 is the article of Embodiments 1 to 9, wherein the membrane has an average thickness less than 1 mm.
Embodiment 11 is the article of Embodiments 1 to 10, wherein the UHMWPE polymer includes from 0.001 mol % to 10 mol % of a comonomer.
According to a 12th embodiment (“Embodiment 12”), provided is method including: lubricating an ultra-high molecular weight polyethylene (UHMWPE) polymer having a molecular weight of at least 2,000,000 g/mol and only a single endotherm with a melt enthalpy of at least 190 J/g to form a lubricated polymer subjecting the lubricated UHMWPE polymer to pressure at a temperature below a melt temperature of the UHMWPE polymer to form a tape; expanding the tape at a temperature below the melt temperature of the UHMWPE polymer to form an expanded tape; and expanding the expanded tape at a temperature above the melt temperature of the UHMWPE polymer to form a porous UHMWPE membrane having a structure of nodes interconnected by fibrils.
Embodiment 13 is the method of Embodiment 12, wherein the ultra-high molecular weight polyethylene (UHMWPE) polymer has a molecular weight of 2,000,000 to 12,000,000 g/mol.
Embodiment 14 is the method of Embodiments 12 or 13, wherein the porous UHMWPE membrane has a first endotherm and a second endotherm from 145° C. to 155° C. that is associated with the fibrils in the porous UHMWPE membrane and that is above the melt temperature of the ultra-high molecular weight polyethylene polymer.
Embodiment 15 is the method of Embodiments 12 to 14, wherein the porous UHMWPE membrane has a bubble point of 138 kPa or less, preferably 69 kPa or less, and more preferably 34.5 kPa or less.
Embodiment 16 is the method of Embodiments 12 to 15, wherein the porous UHMWPE membrane has an ATEQ® airflow of at least 50 L/hr at 1.2 kPa pressure over a surface area of 2.99 cm².
Embodiment 17 is the method of Embodiments 12 to 16, wherein the tape and expanded tape are biaxially expanded, uniaxially expanded, radially expanded, or a combination thereof.
Embodiment 18 is the method of Embodiments 12 to 17, wherein the tape is expanded at a temperature from 110° C. to 135° C.
Embodiment 19 is the method of Embodiments 12 to 18, wherein the tape is expanded at a temperature from 140° C. to 170° C.
Embodiment 20 is the method of Embodiments 12 to 19, wherein the subjecting comprises calendering the lubricated UHMWPE polymer at a temperature below the melt temperature of UHMWPE polymer to form the tape.
Embodiment 21 is the method of Embodiments 12 to 20, including removing the lubricant from the tape prior to expanding.
Embodiment 22 is the method of Embodiments 12 to 21, wherein the UHMWPE polymer has a molecular weight from 5,000,000 g/mol to 12,000,000 g/mol.
Embodiment 23 is the method of Embodiments 12 to 22, wherein the UHMWPE membrane has a porosity greater than 60%.
Embodiment 24 is the method of Embodiments 12 to 23, wherein the UHMWPE membrane has a first endotherm associated with the UHMWPE polymer ranging from 139° C. to 143° C.
Embodiment 25 is the method of Embodiments 12 to 24, wherein the UHMWPE membrane has an average thickness less than 1 mm.
Embodiment 26 is the method of Embodiments 12 to 25, wherein the UHMWPE polymer includes from 0.001 mol % to 10 mol % of a comonomer.
According to a 27th Embodiment, provided is a process including subjecting a lubricated ultra high molecular weight polyethylene (UHMWPE) polymer having a molecular weight of at least 2,000,000 and a first endotherm with a melt enthalpy of at least 190 J/g to pressure and heat below a first melt temperature of the UHMWPE polymer to form a preform, followed by expansion of the preform below the melt temperature of the UHMWPE polymer to form an expanded preform, then followed by an expansion of the expanded preform at a temperature above the melt temperatures of the UHMWPE polymer to form a porous UHMWPE membrane, wherein the porous UHMWPE membrane has a bubble point of 138 kPa or less, preferably 69 kPa or less, and more preferably 34.5 kPa or less, and wherein the porous UHMWPE membrane has an ATEQ® airflow of at least 50 L/hr at 1.2 kPa pressure over a surface area of 2.99 cm².
Embodiment 28 is the method of Embodiment 27, wherein the porous UHMWPE membrane has a second endotherm from 145° C. to 155° C. associated with fibrils in the porous UHMWPE membrane, the second endotherm being above the melt temperature of the UHMWPE polymer.
Embodiment 29 is the method of Embodiments 27 or 28, wherein the preform and expanded preform are biaxially expanded, uniaxially expanded, radially expanded, or a combination thereof.
Embodiment 30 is the method of Embodiments 27 to 29, wherein the preform is expanded at a temperature from about 110° C. to about 135° C.
Embodiment 31 is the method of Embodiments 27 to 30, wherein the preform is expanded at a temperature from 140° C. to 170° C.
Embodiment 32 is the method of Embodiments 27 to 31, wherein the subjecting comprises calendering the lubricated UHMWPE polymer at a temperature below the melt temperature of UHMWPE polymer to form the preform.
Embodiment 33 is the method of Embodiments 27 to 32, including removing the lubricant from the preform prior to expanding.
Embodiment 34 is the method of Embodiments 27 to 33, wherein the UHMWPE polymer has a molecular weight from 2,000,000 g/mol and 12,000,000 g/mol.
Embodiment 35 is the method of Embodiments 27 to 34, wherein the UHMWPE membrane has a porosity greater than 60%.
Embodiment 36 is the method of Embodiments 27 to 35, wherein the UHMWPE membrane has a first endotherm associated with the UHMWPE polymer ranging from 139° C. to 143° C.
Embodiment 37 is the method of Embodiments 27 to 36, wherein the UHMWPE membrane has an average thickness less than 1 mm.
Embodiment 38 is the method of Embodiments 27 to 37, wherein the UHMWPE polymer includes from 0.001 mol % to 10 mol % of comonomer.

The foregoing Embodiments are provided as examples, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTIONS OF FIGURES

The accompanying drawings are included to provide a further understanding of the disclosure and are incorporated in and constitute a part of this specification, illustrate embodiments, and together with the description serve to explain the principles of the disclosure.

FIG. 1 is a scanning electron micrograph (SEM) of the surface of the expanded UHMWPE membrane of Example 1a taken at 1,000× magnification;

FIG. 2 is a scanning electron micrograph (SEM) of the surface of the expanded UHMWPE membrane of Example 1b taken at 1,000× magnification;

FIG. 3 is a scanning electron micrograph (SEM) of the surface of the expanded UHMWPE membrane of Example 2a taken at 100× magnification;

FIG. 4 is a scanning electron micrograph (SEM) of the surface of the expanded UHMWPE membrane of Example 2b taken at 100× magnification;

FIG. 5 is a scanning electron micrograph (SEM) of the surface of the expanded UHMWPE membrane of Comparative Example A taken at 1,000× magnification;

FIG. 6 is a scanning electron micrograph (SEM) of the surface of the expanded UHMWPE membrane of Comparative Example B taken at 1,000× magnification;

FIG. 7 is a differential scanning calorimetry (DSC) thermogram of the UHMWPE powder of all Examples described herein, showing a melt enthalpy of 232.9 J/g;

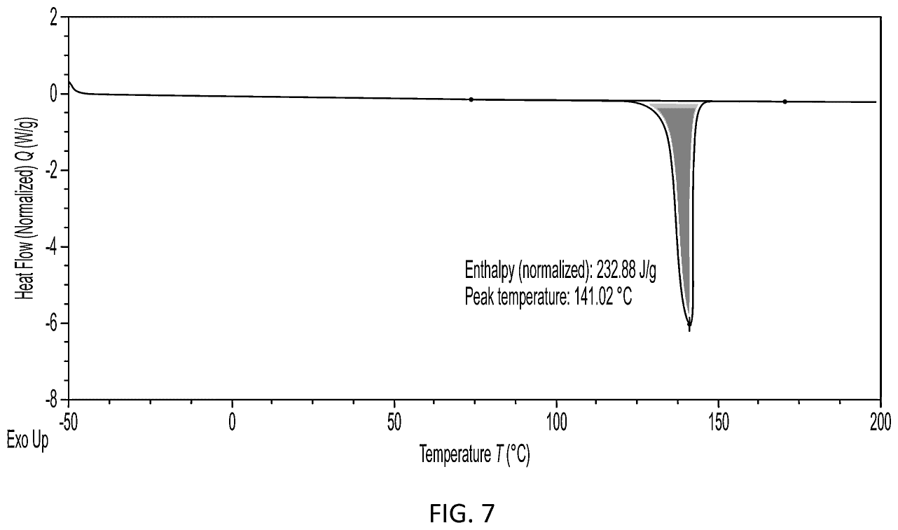

FIG. 8 is a differential scanning calorimetry (DSC) thermogram depicting two distinct melting points associated with the expanded UHMWPE membrane of Example 1a;

FIG. 9 is a differential scanning calorimetry (DSC) thermogram depicting two distinct melting points associated with the expanded UHMWPE membrane of Example 1b;

FIG. 10 is a differential scanning calorimetry (DSC) thermogram depicting two distinct melting points associated with the expanded UHMWPE membrane of Example 2a;

FIG. 11 is a differential scanning calorimetry (DSC) thermogram depicting two distinct melting points associated with the expanded UHMWPE membrane of Example 2b;

FIG. 12 is a differential scanning calorimetry (DSC) thermogram depicting two distinct melting points associated with the expanded UHMWPE membrane of Comparative Example A;

FIG. 13 is a differential scanning calorimetry (DSC) thermogram depicting two distinct melting points associated with the expanded UHMWPE membrane of Comparative Example B; and

FIG. 14 is a differential scanning calorimetry (DSC) thermogram depicting a single melting point typical of a conventional UHMWPE membrane.

### DETAILED DESCRIPTION OF THE INVENTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The disclosure relates articles including a porous membrane formed from ultra-high molecular weight polyethylene (UHMWPE) polymers that may have an average molecular weight (Mw) of at least 2,000,000 g/mol or at least 3,000,000 g/mol, or at least 4,000,000 g/mol, or at least 5,000,000 g/mol, or at least 6,000,000 g/mol, or at least 7,000,000 g/mol and a high degree of crystallinity. In exemplary embodiments, the UHMWPE polymer may have an average molecular weight in the range of from 2,000,000 g/mol to 12,000,000 g/mol, or from 2,000,000 g/mol to 10,000,000 g/mol, or from 4,000,000 g/mol to 10,000,000 g/mol, or from 5,000,000 g/mol to 8,000,000 g/mol, or may have an average molecular weight in the range of any other range encompassed by these endpoints.

The article may be a sheet, a membrane, a tape, a fiber, a tube or a three-dimensional self-supporting structure. In an exemplary embodiment, the article is a tape.

The crystallinity of the UHMWPE polymer may be measured by differential scanning calorimetry (DSC). The UHMWPE polymer has an enthalpy of the first melt at least about 190 J/g. As used herein, the phrases “high crystallinity” or “highly crystalline” are meant to describe a UHMWPE polymer that has a first melt enthalpy greater than 190 J/g as measured by DSC. In another embodiment, the UHMWPE polymer has a first melt enthalpy greater than 195 J/g, 200 J/g, 205 J/g, 210 J/g, 215 J/g, 220 J/g, 225 J/g or 230 J/g.

In addition, the UHMWPE polymer may be a homopolymer of ethylene or a copolymer of ethylene and at least one comonomer. Suitable comonomers that may be used to form a UHMWPE copolymer include, but are not limited to, an alpha-olefin or cyclic olefin having 3 to 20 carbon atoms. Non-limiting examples of suitable comonomers include 1-butene, 1-pentene, 1-hexene, 1-heptene, 1-octene, cyclohexene, and dienes with up to 20 carbon atoms (e.g. butadiene or 1,4-hexadiene). Comonomers may be present in the UHMWPE copolymer in an amount from about 0.001 mol % to about 10 mol %, from about 0.01 mol % to about 5 mol %, from about 0.1 mol % to about 1 mol %, or any other amount encompassed within these endpoints.

Additionally, the ultra-high molecular weight polyethylene UHMWPE polymers of the invention have a melting point from about 139° C. to about 143° C. It is to be noted that the terms “melting temperature”, “melt temperature”, and “melting point” may be used interchangeably herein. In at least one exemplary embodiment, the UHMWPE polymer has a melting point of approximately 140° C. Subsequent re-melting of the UHMWPE polymer occurs at a temperature from about 127° C. to about 137° C.

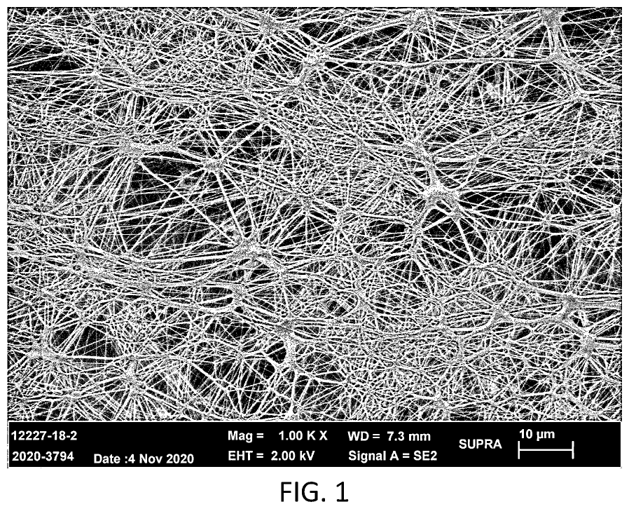

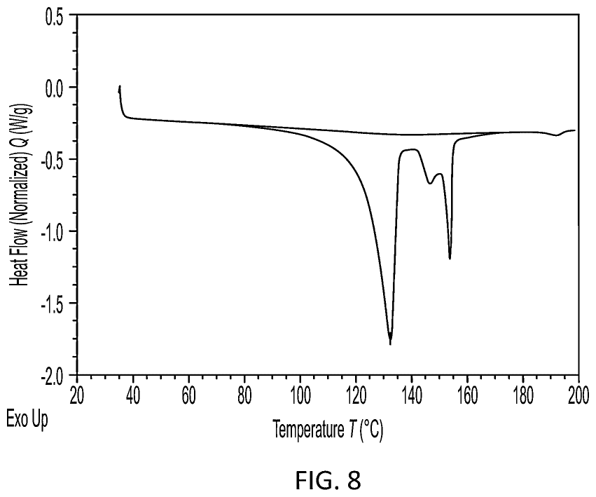

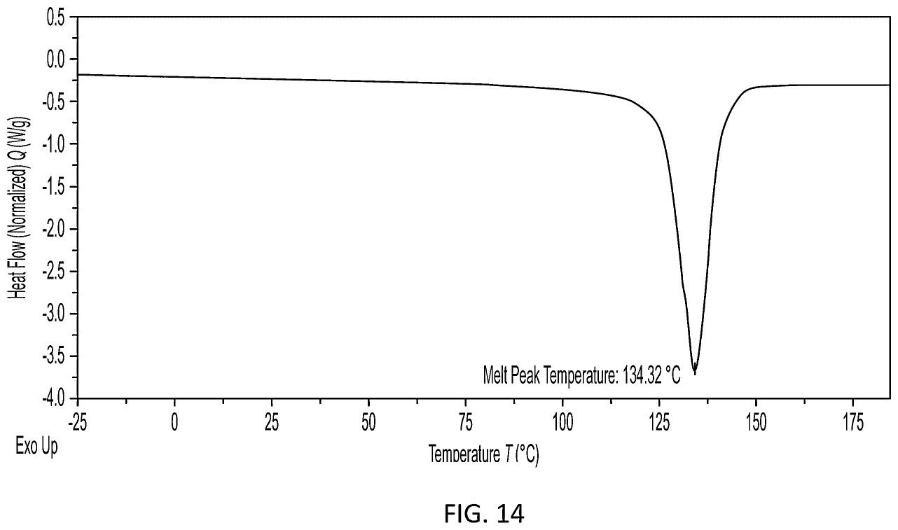

When the UHMWPE polymer is formed into a membrane, the expanded UHMWPE membrane may have a node and fibril structure, as can be seen in FIGS. 1-4. Node, as defined herein, is meant to describe the connection point of at least two fibrils. In addition, the UHMWPE membrane may have an endotherm from about 145° C. to about 155° C., or about 150° C., that is associated with the fibrils in the membrane. Differential Scanning calorimetry (DSC) can be used to identify the melting temperatures (crystalline phases) of the UHMWPE polymers. FIG. 8 shows a DSC thermograph of an exemplary UHMWPE membrane having a reduced melt temperature at about 132° C. and an endotherm at approximately 152° C. This approximate 150° C. peak (or endotherm) is indicative of the presence of fibrils in the expanded UHMWPE membrane. It is to be appreciated that an endothermic peak of about 150° C. is not present in conventional processed UHMWPE porous membranes, but is present in the UHMWPE membranes described for example U.S. Pat. No. 9,926,416. A DSC thermograph for a conventional UHMWPE membrane is shown in FIG. 14, depicting the single melting peak (melting temperature) at approximately 134° C.

A membrane formed from the UHMWPE polymer may have a percent porosity that is greater than or equal to about 60%, greater than or equal to about 65%, greater than or equal to about 70%, greater than or equal to about 75%, greater than or equal to about 80%, greater than or equal to about 85%, greater than or equal to about 90%. In exemplary embodiments, the membrane formed from the UHMWPE polymer may have a percent porosity from about 25% to about 90%, from about 40% to about 90%, from about 50% to about 90%, from about 60% to about 90%, or any may have any percent porosity encompassed by these endpoints.

A membrane formed from the UHMWPE polymer may have a bubble point, of about 138 kPa or less, of about 100 kPa or less, of about 69.0 kPa or less, of about 50 kPa or less, of about 34.5 kPa or less, of about 20 kPa or less, of about 10 kPa or less, of about 8 kPa or less, of about 7 kPa or less, of about 6 kPa or less, of about 5 kPa or less, of about 4 kPa or less, of about 3 kPa or less, of about 2 kPa or less, of about 1 kPa or less. In exemplary embodiments, the membrane may have a bubble point from about 1 kPa to about 138 kPa, from about 2 kPa to about 100 kPa, or from about 3 kPa to 10 kPa, or may have a bubble point encompassed within these ranges.

A membrane formed from the UHMWPE polymer may have an ATEQ airflow of at least about 50 L/hr at 1.2 kPa pressure over a surface area of 2.99 cm², or of at least about 70 L/hr at 1.2 kPa pressure over a surface area of 2.99 cm², of at least about 100 L/hr at 1.2 kPa pressure over a surface area of 2.99 cm², of at least about 500 L/hr at 1.2 kPa pressure over a surface area of 2.99 cm², of at least about 1000 L/hr at 1.2 kPa pressure over a surface area of 2.99 cm², of at least about 2000 L/hr at 1.2 kPa pressure over a surface area of 2.99 cm², of at least about 3000 L/hr at 1.2 kPa pressure over a surface area of 2.99 cm², or of at least about 4000 L/hr at 1.2 kPa pressure over a surface area of 2.99 cm². In exemplary embodiments, the membrane may have an ATEQ airflow from about 50 L/hr to about 4000 L/hr at 1.2 kPa pressure over a surface area of 2.99 cm², from about 100 L/hr to about 3000 L/hr at 1.2 kPa pressure over a surface area of 2.99 cm², or from about 1000 L/hr to about 2000 L/hr at 1.2 kPa pressure over a surface area of 2.99 cm².

A membrane formed from the UHMWPE polymer may have a matrix tensile strength (MTS) in the machine direction (MD) of at least about 30 MPa, of at least about 50 MPa, of at least about 100 MPa, of at least about 150 MPa, or of at least about 200 MPa. In exemplary embodiments, the membrane may have a matrix tensile strength in the machine direction of from about 30 MPa to about 200 MPa, of from about 50 MPa to about 100 MPa, or of from about 30 MPa to about 100 MPa.

A membrane formed from the UHMWPE polymer may have a matrix tensile strength (MTS) in the transverse direction (TD) (orthogonal to the MD) of at least about 4 MPa, of at least about 10 MPa, of at least about 50 MPa, or of at least about 100 MPa. In exemplary embodiments, the membrane may have a matrix tensile strength in the transverse direction of from about 4 MPa to about 100 MPa, or of from about 50 MPa to about 100 MPa.

A membrane formed from the UHMWPE polymer may have a ratio of matrix tensile strength determined as MD:TD from about 0.1:1 to 1:0.1, or from about 0.5:1 to 1:0.5, or from about 0.7:1 to 1:0.7.

A membrane formed from the UHMWPE polymer may have an average thickness of less than about 1 mm, or less than about 0.75 mm, or less than about 0.5 mm, or less than about 0.25 mm, or less than about 0.09 mm, or less than about 0.08 mm, or less than about 0.07 mm, or less than about 0.06 mm, or less than about 0.05 mm. In exemplary embodiments, the membrane may have a thickness from about 0.005 mm to about 1 mm, or about 0.01 mm to about 1 mm, or about 0.03 mm to about 1 mm, or about 0.05 mm to about 1 mm, or from about 0.08 to about 0.5 mm, or any may have a thickness encompassed within these ranges.

The membrane formed from the UHMWPE polymer may have a maximum pore size (calculated based on bubble point) of about 30 μm or less, or about 25 μm or less, or about 20 μm or less, or about 15 μm or less, or about 10 μm or less. In exemplary embodiments, the maximum pore size is in the range of about 0.5 μm to about 30 μm, or about 0.5 μm to about 25 μm, or about 0.5 μm to about 20 μm.

The UHMWPE polymer described herein may be manufactured by a polymerization process where ethylene, optionally a modified or slightly modified ethylene, and optionally in the presence of a comonomer, is polymerized in the presence of a polymerization catalyst at a temperature below the crystallization temperature of the polymer. Such polymerization causes the polymer to crystallize immediately after formation. More specifically, the reaction conditions are selected so that the polymerization speed is lower than the crystallization speed. Such synthesis conditions force the molecular chains to crystallize immediately upon their formation, leading to a morphology that differs from that which is obtained by the solution or melt. It is to be noted that the crystalline morphology created at the surface of a catalyst will depend on the ratio between the crystallization rate and the growth of the polymer. Further, the synthesis temperature, which in this case is also the crystallization temperature, will influence the morphology of the thus obtained UHMWPE polymer. With UHMWPE polymers, the particle size, shape, and distribution thereof are important to obtain the desired porous structures. These particle characteristics affect the packing density as well as connection density, thereby affecting the porous structures that can be produced from the particles.

The UHMWPE resin may be provided in a particulate form, for example, in the form of a powder. UHMWPE powders may be formed of individual particles having a particulate size less than about 100 nm. Typically powders are supplied as a cluster of particles having size from about 5 to about 250 microns or from about 10 microns to about 200 microns. In exemplary embodiments, the clusters may have a size as small as possible, down to and including individual particles.

In forming a porous article from the UHMWPE polymer, the UHMWPE polymer is first mixed with a lubricant, such as a light mineral oil. Other suitable lubricants include aliphatic hydrocarbons, aromatic hydrocarbons, halogenated hydrocarbons, and the like, that are selected according to flammability, evaporation rate, and economical considerations. It is to be appreciated that the term “lubricant”, as used herein, is meant to describe a processing aid consisting of an incompressible fluid that is not a solvent for the polymer at the process conditions. The fluid-polymer surface interactions are such that it is possible to create a homogenous mixture. It is also to be noted that that choice of lubricant is not particularly limiting, and the selection of lubricant is largely a matter of safety and convenience. The lubricant may be added to the UHMWPE polymer in a ratio 1 ml/100 g to about 100 ml/100 g or from about 10 ml/100 g to about 70 ml/100 g. In one embodiment the lubricant is added, the mixture is maintained below the melt temperature of the UHMWPE polymer for a period of time (i.e., dwell time) sufficient to wet the interior of the clusters of the polymer with the lubricant. A “sufficient period of time” may be described as a time period sufficient for the particles to return to a free-flowing powder. In another embodiment, the lubricant is added and mixed with the UHMWPE polymer where the mixture is free flowing and does not require a dwell time.

After the lubricant has been uniformly distributed to the surface of the particles (e.g., wet the interior of the clusters), the mixture returns to a free flowing, powder-like state. In exemplary embodiments, the mixture is heated to a temperature below the melt temperature of the UHMWPE polymer or the boiling point of the lubricant, whichever is lower. It is to be appreciated that various times and temperatures may be used to wet the polymer so long as the lubricant has a sufficient time to adequately wet the interior of the clusters.

Once lubricated, the particles can be formed into solid shapes or a preform, without exceeding the melt temperature of the polymer. In exemplary embodiment, the preform may be a fiber, a tube, a tape, a sheet, a bead or a three-dimensional self-supporting structure. The lubricated particles are heated to a point below melting temperature of the polymer and with the application of sufficient pressure and shear to form inter-particle connections and create a solid form. Non-limiting examples of methods of applying pressure and shear include ram extrusion, typically called paste extrusion or paste processing when lubricant is present, and optional calendering.

In an exemplary embodiment, the lubricated UHMWPE polymer is calendered to produce a cohesive, flexible tape. As used herein, the term “cohesive” is meant to describe a tape that is sufficiently strong for further processing. The calendering occurs from about 115° C. to about 135° C. or from about 120° C. to about 130° C. The tape formed has an indeterminate length and a thickness less than about 1 mm. Tapes may be formed that have a thickness from about 0.01 mm to about 1 mm from about 0.08 mm to about 0.5 mm, or from 0.05 mm to 0.2 mm, or even thinner. In exemplary embodiments, the tape has a thickness from about 0.05 mm to about 0.2 mm.

In a subsequent step, the lubricant may be removed from the tape. In instances where a mineral oil is used as the lubricant, the lubricant may be removed by washing the tape in hexane or other suitable solvent. The wash solvent is chosen to have excellent solubility for lubricant and sufficient volatility to be removed below the melting point of the resin. If the lubricant is of sufficient volatility, the lubricant may be removed without a washing step, or it may be removed by heat and/or vacuum. The tape is then optionally permitted to dry, typically by air drying. However, any conventional drying method may be used as long as the temperature of heating the sample remains below the melting point of the UHMWPE polymer.

The first melting temperature of the highly crystalline UHMWPE polymer, i.e., from approximately 139° C. to approximately 143° C., is irreversible in that subsequent melting and re-crystallization occurs at a lower temperature (second melting temperature) than the first melting temperature. The second melting temperature of the UHMWPE polymer is approximately 127° C. to approximately 137° C. A unique feature of some embodiments of this invention is that the higher first melting temperature may be retained in the final porous article. Additionally, there is a surprising feature in the DSC of the inventive UHMWPE membranes in that the inventive UHMWPE membranes show an endotherm at approximately 150° C. associated with the fibrils, which is at a temperature higher than the melting temperature associated with the original UHMWPE polymer prior to processing.

The tapes, once dried, are cut to suitable sizes for expansion. Expansion of these samples occurs at two temperature regimes: 1) below the melt temperature of the UHMWPE polymer, from about 110° C. to about 135° C. or from about 125° C. to about 130° C.; or 2) above the melt temperature of the UHMWPE polymer, from about 140° C. to about 170° C. or from about 150° C. to about 160° C. The samples may be expanded in one or more directions to form a porous membrane. Expansion, either uniaxial or biaxial, may be conducted at rates up to 20,000%/second, or from about 0.1% to 20,000%/second. For processes conducted below the melt, an increase in strength concurrently occurring upon expansion has been observed. Generally, strength of the polymer matrix is dependent upon the strength of the tape prior to expansion, the quality of the resin (e.g., particle size, molecular weight, distribution of particle size and/or molecular weight, degree of crystallinity, composition of polymer, and the like) the temperature at which expansion is performed, the rate of expansion, and the total amount of expansion.

The expanded membrane has a structure of nodes interconnected by fibrils, such as may be seen in FIGS. 1-4. The porous microstructure of the expanded membrane is affected by the temperature and rate at which it is expanded. The geometry of the nodes and fibrils can be controlled by the selection of resin, the rate of expansion, temperature of expansion, and ultimate expansion ratio. Membranes that that have been expanded first below, and subsequently above the melt temperature of the UHMWPE polymer tend to have larger nodes separated by fewer interconnected fibrils and larger void spaces.

### Test Methods

It should be understood that although certain methods and equipment are described below, any method or equipment determined suitable by one of ordinary skill in the art may be alternatively utilized. For characterization purposes, two 17.8 cm×17.8 cm squares of material were used.

### Contact Thickness Measurements

Thickness was measured by placing the sample flat on a granite block and using a hand-actuated Mitutoyo thickness gauge (Mitutoyo Corporation, Kawasaki, Japan) with a 6.35 mm metal plate. The average and standard deviation of three measurements was used for the Percent Porosity Calculation described below.

### Percent Porosity Calculation

Density was used to calculate the percent porosity of expanded materials using 0.94 g/cm³ as the full density of the sample. Samples were die cut and weighed using a balance. This data, along with the measured thickness, was used to calculate the density of a membrane according to the following formula:

$$ρ = \frac{m}{w \times l \times t} \\ where : ρ = density ( g / {cm}^{3} ) \\ m = mass ( g ) \\ w = width ( cm ) \\ l = length ( cm ) \\ t = thickness ( cm )$$

Percent Porosity was subsequently calculated using the following formula:

$$Porosity ( \% ) = ( 1 - \frac{ρ}{0.94} ) \times 100 \\ where : ρ = density ( g / {cm}^{3} )$$

The reported results are the average of four calculations.

### Matrix Tensile Strength (MTS)

A sample was cut in each of the longitudinal and transverse directions using an ASTM D412-Dogbone die Type F (D412F). Tensile break load was measured using an INSTRON 5500R tensile test machine (Illinois Tool Works Inc., Norwood, MA) equipped with flat-faced grips and a 500N load cell. The gauge length was 19 mm and the cross-head speed was 20.3 cm/min. For longitudinal MTS measurements, the larger dimension of the sample was oriented in the calendering direction, which was designated the “machine direction” (MD). For the transverse MTS measurements, the larger dimension of the sample was oriented perpendicular to the calendering direction, which was designated the “transverse direction” (TD).

The sample from the density measurement was used for tensile testing. The sample dimensions were 50.8 mm by 12.7 mm. The effective thickness is calculated from the mass, the area, and the density of the sample. Two samples were then tested individually on the tensile tester. The average of the two maximum load (i.e., the peak force) measurements was reported. The longitudinal and transverse MTS were calculated using the following equation:

$$MTS = ( maximum load / cross - section area ) * ( density of UHMWPE ) / density of the sample ) ,$$

wherein the density of UHMWPE is taken to be 0.94 g/cc.

### Bubble Point Measurements

Bubble point pressures were measured according to the general teachings of ASTM F31 6-03 using a Sprint iQ Multi-Function Leak and Flow Tester (Uson LP, Houston, TX). The sample membrane was placed into the sample chamber and wet with 100% Isopropyl Alcohol having a surface tension of 21.7 dynes/cm to fill the pores of the sample. The sample was then secured by a 20 mm diameter O-ring sealing the membrane against a porous metal surface. Starting at an initial pressure of 0 psi, air pressure was applied to one side of the sample and was ramped at 0.05 psi/min until a pressure increase of 0.20 psi was measured on the opposing side of the sample. This pressure is the Bubble Point, or the pressure of air required to displace the isopropyl alcohol from the largest pores of the test specimen. The reported value represents the average and standard deviation of four measurements and was used to estimate the maximum pore size. The bubble point pressure was converted to a maximum pore size (“calculated maximum pore size”) using the following equation:

$$DBP = 4 γ lv cos θ / PBP$$

where DBP is the calculated maximum pore size, γ|v is the liquid surface tension, θ is the contact angle of the fluid on the material surface, and PBP is the bubble point pressure. It is understood by one skilled in the art that the fluid used in a bubble point measurement must wet the surface of the sample. Isopropyl alcohol completely wets the UHMWPE surface, thus the contact angle is 0° and the cos (e) term is equal to 1.

### ATEQ® Air Flow

ATEQ® Airflow is a test method for measuring volumetric flow rates of air through a sample. Each sample was clamped between two plates with an #210 or equivalent O-ring on each plate with an open hole in between the O-ring in a manner that creates a sealed area of 2.99 cm² across the flow pathway. The hole in the flow path on the downstream side had a grid support structure across it. An ATEQ® (ATEQ Corp., Livonia, Mich.) Premier D Compact Flow Tester or equivalent was used to measure airflow rate (L/hr) through each sample by challenging it with a differential air pressure of 1.2 kPa (12 mbar) across the sample. The reported results are the average and standard deviation of four measurements.

### SEM Surface Sample Preparation Method (Sample Layout 2)

All SEM samples were imaged at 2.0 keV using a Zeiss SUPRA 35VP scanning electron microscope (Zeiss Microscopy, Jena, Germany) in secondary electron detection mode.

### DSC Measurements

Differential Scanning calorimetry (DSC) data was collected using a TA Instruments Discovery DSC (TA Instruments, New Caste, DE) between either −50° C. or 35° C. and 200° C. using a heating rate of 10° C./min. For resins samples, approximately 5 mg of powder was placed into a standard pan-and-lid combination available from TA instruments. The membrane samples were prepared by punching 4 mm disks. The 4 mm disk was placed flat in the pan and the lid was crimped to sandwich the membrane disk between the pan and lid. A linear integration scheme from 80° C. to 180° C. was used to integrate the melting enthalpy data. Subsequent de-convolution of the melting region was accomplished using the PeakFit software from SeaSolve Software (PeakFit v4.12 for Windows, Copyright 2003, SeaSolve Software Inc.) Standard conditions were used to fit a baseline (after inverting the data to generate “positive” peaks) and subsequently resolve the observed data into its individual melting components.

### EXAMPLES

It is to be understood that the following examples were conducted on a lab scale but could be readily adapted to a continuous or semi-continuous process.

### Example 1a

### Powder Preparation:

100 g of Ultrahigh Molecular Weight Polyethylene powder having a molecular weight of approximately 7,000,000 g/mol prepared as reported in Patent No WO2012053261 and a melt enthalpy in excess of 190 J/g as determined by DSC was placed in a 2-liter screw cap jar. Isoparaffinic hydrocarbon lubricant (60 mL) of ISOPAR™ V (ExxonMobil Chemical Company, Spring, Texas) was added and mixed at room temperature for 15 minutes at 30 rpm using a tumbler. The mixture was preheated to 60° C. prior to calendering.

### Tape Calender Process:

On a calender machine, 30.5 cm diameter rolls were preheated to 124° C. with the gap between the rolls set at 0.15 mm. The lubricated polymer was introduced into the gap with a feeder to produce a 15.2 cm wide continuous tape. The tape was opaque, flexible, and approximately 0.17 mm thick.

### Removal of Lubricant:

The tape was washed for 2 hours via extraction in boiling hexane using a Soxhlet extractor and subsequently air dried at room temperature (˜22° C.) in a fume hood.

### Biaxial Expansion:

Samples were cut from the tape and placed in a Karo IV biaxial expansion machine (commercially available from Brückner Group, GmbH, Siegsdorf, Germany) and simultaneously stretched according to the steps below:
1. Preheat the sample at 135° C. for 30 seconds
2. At 135° C.: Tape was expanded at a stretch ratio of 1.5 at 150%/s in the calendered direction and 2.0 at 300%/s in the transverse (perpendicular to the calender) direction
3. Preheat the sample at 160° C. for 15 seconds
4. At 160° C.: An additional stretch ratio of 4.5 at 0.7%/s in the calendered direction and 8.0 at 1.4%/s in the transverse direction

A scanning electron micrograph (SEM) of the surface of the expanded UHMWPE membrane taken at 1,000× magnification is shown in FIG. 1. A differential scanning calorimetry (DSC) thermogram depicting two distinct melting points associated with the expanded UHMWPE membrane of Example 1a is included in FIG. 8.

Properties of the biaxially expanded membrane are provided in Table 1.

### Example 1b

The powder preparation, tape calendaring, and lubricant removal were prepared using the methods described in Example 1a.

### Biaxial Expansion:

Samples were biaxially expanded according to the steps below:
1. Preheat the sample at 135° C. for 30 seconds
2. At 135° C.: Tape was expanded at a stretch ratio of 1.5 at 40%/s in the calendered direction and 2.0 at 80%/s in the transverse (perpendicular to the calender) direction
3. At 160° C.: An additional stretch ratio of 2.67 at 0.7%/s in the calendered direction and 5.0 at 2.2%/s in the transverse (perpendicular to the calender) direction

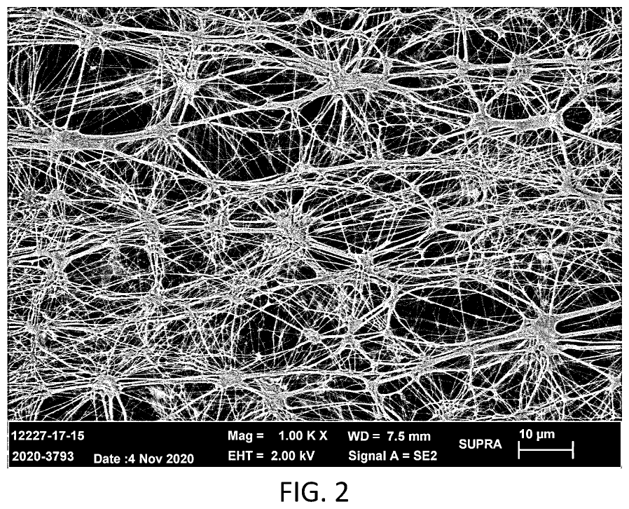

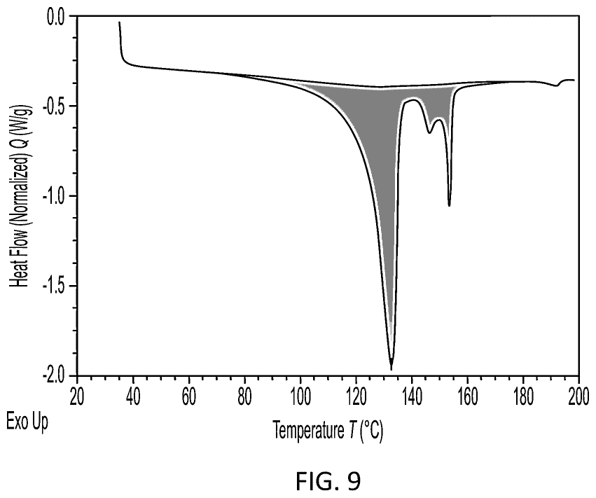

A scanning electron micrograph (SEM) of the surface of the expanded UHMWPE membrane taken at 1,000× magnification is shown in FIG. 2. A differential scanning calorimetry (DSC) thermogram depicting two distinct melting points associated with the expanded UHMWPE membrane of Example 1b is included in FIG. 9.

Properties of the biaxially expanded membrane are provided in Table 1.

### Example 2a

The powder preparation, tape calendaring, and lubricant removal were prepared using the methods described in Example 1a.

### Biaxial Expansion:

Samples were biaxially expanded according to the steps (1-3) outlined in Example 1a, with the exceptions of Steps 3 and 4 being carried out at 135° C. and the addition of Step 5.
1. Preheat the sample at 135° C. for 30 seconds
2. At 135° C.: Tape was expanded at a stretch ratio of 1.5 at 150%/s in the calendered direction and 2.0 at 300%/s in the transverse (perpendicular to the calender) direction
3. Preheat the sample at 135° C. for 15 seconds
4. At 135° C.: An additional stretch ratio of 4.5 at 0.7%/s in the calendered direction and 8.0 at 1.4%/s in the transverse direction
5. Post expansion dwell of 30 seconds at 160° C.

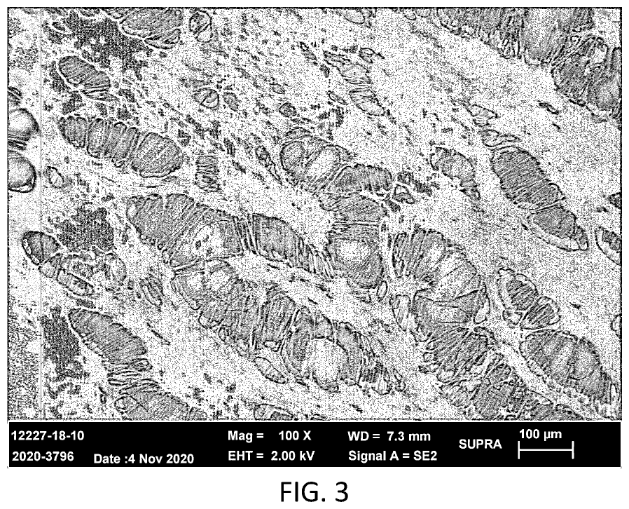

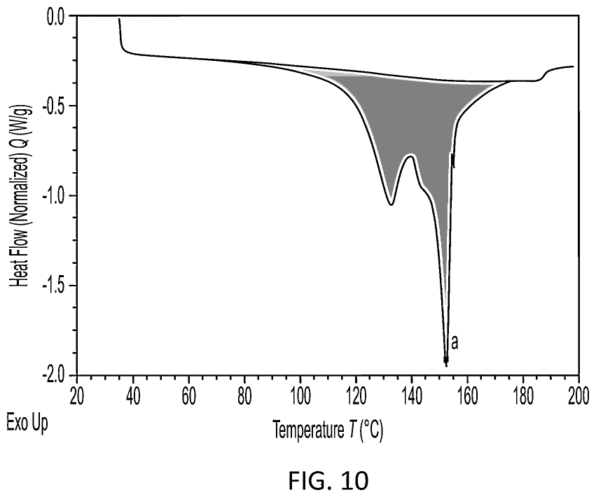

A scanning electron micrograph (SEM) of the surface of the expanded UHMWPE membrane taken at 1,000× magnification is shown in FIG. 3. A differential scanning calorimetry (DSC) thermogram depicting two distinct melting points associated with the expanded UHMWPE membrane of Example 2a is included in FIG. 10.

Properties of the biaxially expanded membrane are provided in Table 1.

### Example 2b

The powder preparation, tape calendaring, and lubricant removal were prepared using the methods described in Example 1a.

### Biaxial Expansion:

Samples were biaxially expanded according to the steps (1-3) outlined in Example 1b, with the exception of Step 3 being carried out at 135° C. and the addition of Step 4.
1. Preheat the sample at 135° C. for 30 seconds
2. At 135° C.: Tape was expanded at a stretch ratio of 1.5 at 40%/s in the calendered direction and 2.0 at 80%/s in the transverse (perpendicular to the calender) direction
3. At 135° C.: An additional stretch ratio of 2.67 at 0.7%/s in the calendered direction and 5.0 at 2.2%/s in the transverse (perpendicular to the calender) direction
4. Post expansion dwell of 30 seconds at 160° C.

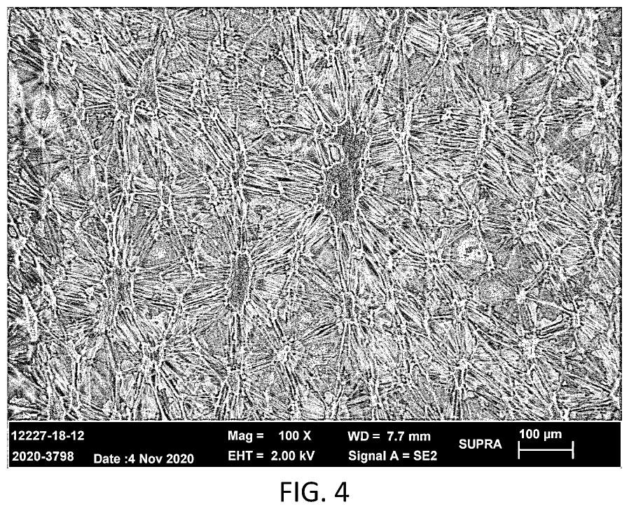

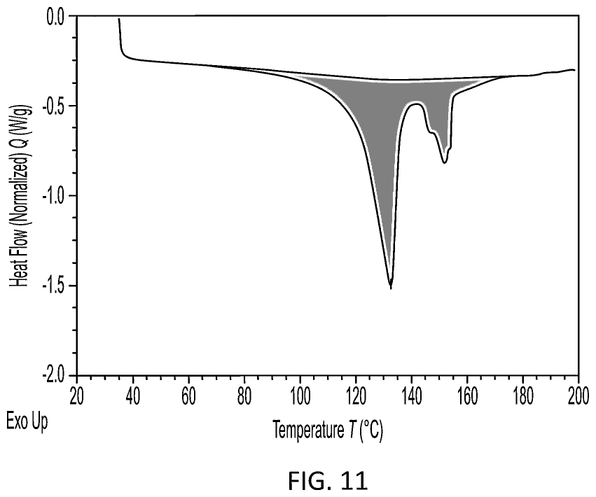

A scanning electron micrograph (SEM) of the surface of the expanded UHMWPE membrane taken at 1,000× magnification is shown in FIG. 4. A differential scanning calorimetry (DSC) thermogram depicting two distinct melting points associated with the expanded UHMWPE membrane of Example 2b is included in FIG. 11.

Properties of the biaxially expanded membrane are provided in Table 1.

### Comparative Example A

The powder preparation, tape calendaring, and lubricant removal were prepared using the methods described in Example 1a. Biaxial expansion was carried out entirely below the melt of the UHWMPE polymer with no post expansion exposure to above the melt temperatures, in accordance with Example 1 of U.S. Pat. No. 9,926,416.

### Biaxial Expansion:

Samples were biaxially expanded according to the steps 1-4 outlined in Example 2a, omitting the post expansion dwell at 160° C. (Step 5).
1. Preheat the sample at 135° C. for 30 seconds
2. At 135° C.: Tape was expanded at a stretch ratio of 1.5 at 150%/s in the calendered direction and 2.0 at 300%/s in the transverse (perpendicular to the calender) direction
3. Preheat the sample at 135° C. for 15 seconds
4. At 135° C.: An additional stretch ratio of 4.5 at 0.7%/s in the calendered direction and 8.0 at 1.4%/s in the transverse direction

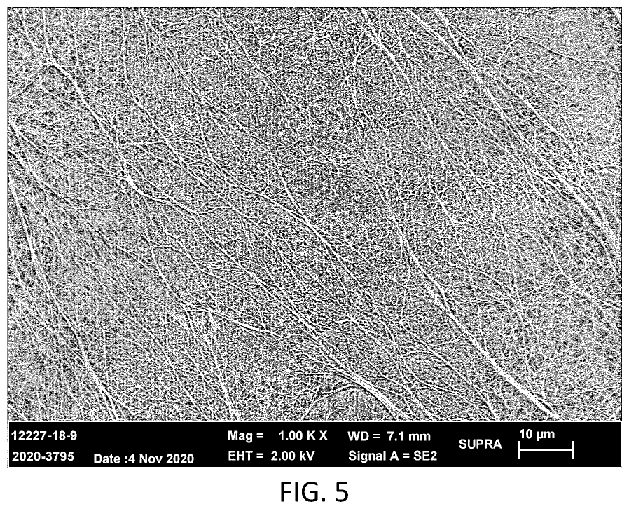

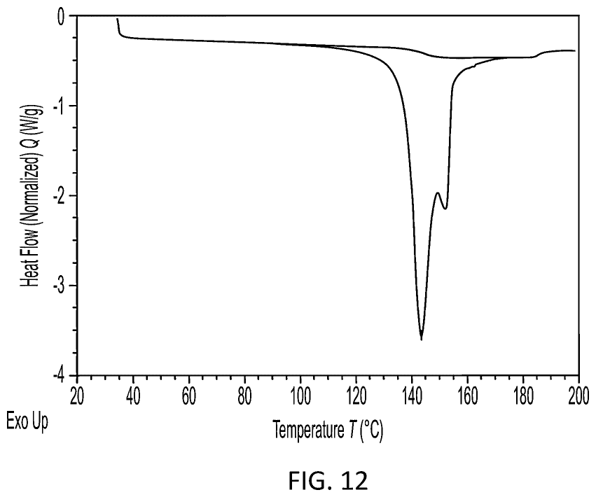

A scanning electron micrograph (SEM) of the surface of the expanded UHMWPE membrane taken at 1,000× magnification is shown in FIG. 5. A differential scanning calorimetry (DSC) thermogram depicting two distinct melting points associated with the expanded UHMWPE membrane of Comparative Example A is included in FIG. 12.

Properties of the biaxially expanded membrane are provided in Table 1.

### Comparative Example B

The powder preparation, tape calendaring, and lubricant removal were prepared using the methods described in Example 1a. Biaxial expansion was carried out entirely below the melt of the UHWMPE polymer with no post expansion exposure to above the melt temperatures, in accordance with Example 1 of U.S. Pat. No. 9,926,416.

### Biaxial Expansion:

Samples were biaxially expanded according to the steps 1-4 outlined in Example 2b, omitting the post expansion dwell at 160° C. (Step 4).
1. Preheat the sample at 135° C. for 30 seconds
2. At 135° C.: Tape was expanded at a stretch ratio of 1.5 at 40%/s in the calendered direction and 2.0 at 80%/s in the transverse (perpendicular to the calender) direction
3. At 135° C.: An additional stretch ratio of 2.67 at 0.7%/s in the calendered direction and 5.0 at 2.2%/s in the transverse (perpendicular to the calender) direction

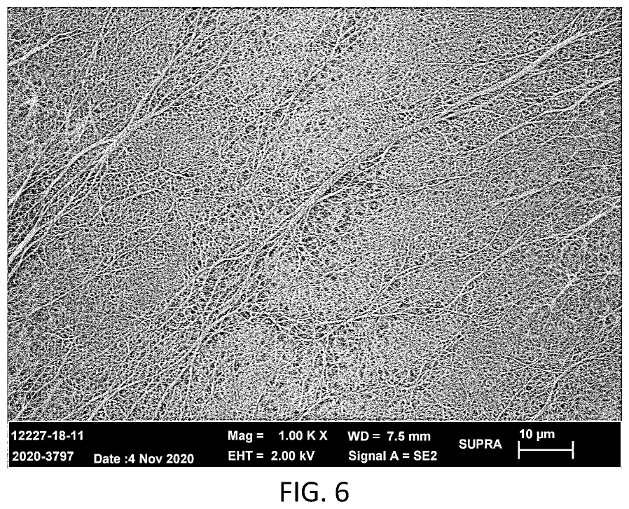

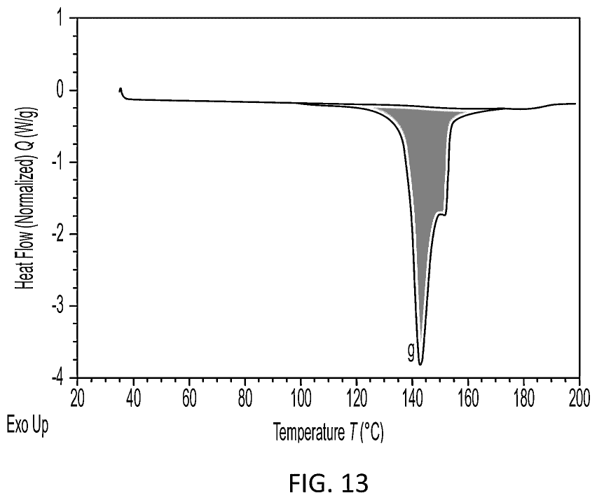

A scanning electron micrograph (SEM) of the surface of the expanded UHMWPE membrane taken at 1,000× magnification is shown in FIG. 6. A differential scanning calorimetry (DSC) thermogram depicting two distinct melting points associated with the expanded UHMWPE membrane of Comparative Example B is included in FIG. 13.

Properties of the biaxially expanded membrane are provided in Table 1.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

TABLE 1
Summary table of biaxially expanded membrane properties.

| | | | | Calculated | | | |
|---|---|---|---|---|---|---|---|
| | | ATEQ ® | Bubble | Maximum | Contact | MTS | MTS |
| | Porosity | Airflow | Point | Pore size | Thickness | MD | TD |
| Sample | (%) | (L/hr) | (kPa) | (μm) | (μm) | (MPa) | (MPa) |
| Example 1a | 90.0 | 1309 ± 217 | 15.4 ± 0.4 | 5.6 | 6.7 ± 2.1 | 112 | 70 |
| Example 1b | 93.8 | 1431 ± 219 | 9.5 ± 0.3 | 9.1 | 28.0 ± 6.9 | 81 | 46 |
| Example 2a | 53.1 | 4256 ± 3916 | 3.4 ± 1.8 | 25.5 | 3.0 ± 1.0 | 129 | 56 |
| Example 2b | 84.3 | 4857 ± 1258 | 3.5 ± 0.3 | 24.8 | 14.3 ± 1.5 | 33 | 4 |
| Comp. Ex. A | 75.9 | 29.2 ± 0.8 | 542.1 ± 17.6 | 0.16 | 6.7 ± 0.6 | 536 | 357 |
| Comp. Ex. B | 83.3 | 19.7 ± 0.3 | 383.0 ± 22.5 | 0.23 | 24.3 ± 0.6 | 286 | 275 |

1.-38. (canceled)

39. An article comprising:
a porous polyethylene membrane formed from an ultra-high molecular weight polyethylene (UHMWPE) polymer having:
a molecular weight of at least 2,000,000 g/mol; and
a melt enthalpy of at least 190 J/g;
wherein the porous polyethylene membrane includes:
a node and fibril microstructure having a structure of nodes interconnected by fibrils;
a detectable first endotherm associated with the UHMWPE polymer ranging from about 139° C. to about 143° C.;
a detectable second endotherm from 145° C. to 155° C. associated with the fibrils, and
a bubble point of 138 kPa or less, preferably 69.0 kPa or less, and more preferably 34.5 kPa or less.

40. The article of claim 39, wherein the porous polyethylene membrane has an ATEQ® airflow of at least 50 L/hr, preferably at least 500 L/hr, and more preferably at least 1000 L/hr at 1.2 kPa pressure over a surface area of 2.99 cm², or wherein the porous polyethylene membrane has a matrix tensile strength in the machine direction (MD) of at least 30 MPa, or wherein the porous polyethylene membrane has a matrix tensile strength in the transverse direction (TD) of least 4 MPa.

41. The article of claim 39, wherein the membrane is biaxially oriented.

42. The article of claim 39, wherein the ratio of the matrix tensile strength MD:TD is from 0.1:1 to 1:0.1, or wherein the UHMWPE polymer has a molecular weight from 2,000,000 g/mol to 12,000,000 g/mol.

43. The article of claim 39, wherein the article is a sheet, membrane, tape, fiber, tube, bead or a three-dimensional self-supporting structure.

44. The article of claim 39, wherein the porous membrane has a porosity of at least 60%.

45. The article of claim 39, wherein the UHMWPE polymer includes from 0.001 mol % to 10 mol % of a comonomer.

46. A method comprising:
lubricating an ultra-high molecular weight polyethylene (UHMWPE) polymer having a molecular weight of at least 2,000,000 g/mol and only a single endotherm with a melt enthalpy of at least 190 J/g to form a lubricated polymer
subjecting the lubricated UHMWPE polymer to pressure at a temperature below a melt temperature of the UHMWPE polymer to form a tape;
expanding the tape at a temperature below the melt temperature of the UHMWPE polymer to form an expanded tape; and
expanding the expanded tape at a temperature above the melt temperature of the UHMWPE polymer to form a porous UHMWPE membrane having a structure of nodes interconnected by fibrils.

47. The method of claim 46, wherein the porous UHMWPE membrane has a molecular weight of 2,000,000 g/mol to 12,000,000 g/mol, or wherein the porous UHMWPE membrane has a first endotherm and a second endotherm from 145° C. to 155° C. that is associated with the fibrils in the porous UHMWPE membrane and that is above the melt temperature of the ultra high molecular weight polyethylene polymer, or wherein the porous UHMWPE membrane has a bubble point of 138 kPa or less, preferably 69 kPa or less, and more preferably 34.5 kPa or less, or wherein the porous UHMWPE membrane has an ATEQ® airflow of at least 50 L/hr, preferably at least 500 L/hr, and most preferably at least 1000 L/hr at 1.2 kPa pressure over a surface area of 2.99 cm².

48. The method of claim 46, wherein the tape and expanded tape are biaxially expanded, uniaxially expanded, radially expanded, or a combination thereof.

49. The method of claim 47, wherein the tape is expanded at a temperature from 110° C. to 135° C., or wherein the tape is expanded at a temperature from 140° C. to 170° C.

50. The method according to claim 46, wherein the subjecting comprises calendering the lubricated UHMWPE polymer at a temperature below the melt temperature of UHMWPE polymer to form the tape.

51. The method according to claim 46, comprising removing the lubricant from the tape prior to expanding.

52. The method according to claim 46, wherein the UHMWPE polymer has a molecular weight from 5,000,000 g/mol and 12,000,000 g/mol, or wherein the UHMWPE membrane has a porosity greater than 60%, or wherein the UHMWPE membrane has a first endotherm associated with the UHMWPE polymer ranging from 139° C. to 143° C., or wherein the UHMWPE polymer includes from 0.001 mol % to 10 mol % of a comonomer.

53. A process comprising subjecting a lubricated ultra high molecular weight polyethylene (UHMWPE) polymer having a molecular weight of at least 2,000,000 and a first endotherm with a melt enthalpy of at least 190 J/g to pressure and heat below a first melt temperature of the UHMWPE polymer to form a preform, followed by expansion of the preform below the melt temperature of the UHMWPE polymer to form an expanded preform, then followed by an expansion of the expanded preform at a temperature above the melt temperatures of the UHMWPE polymer to form a porous UHMWPE membrane,
wherein the porous UHMWPE membrane has a bubble point of 138 kPa or less, preferably 69.0 kPa or less, and more preferably 34.5 kPa or less, and
wherein the porous UHMWPE membrane has an ATEQ® airflow of at least 50 L/hr, preferably at least 500 L/hr, and more preferably at least 1000 L/hr at 1.2 kPa pressure over a surface area of 2.2 cm².

54. The method of claim 53, wherein the porous UHMWPE membrane has a second endotherm from 145° C. to 155° C. associated with fibrils in the porous UHMWPE membrane, the second endotherm being above the melt temperature of the UHMWPE polymer.

55. The method of claim 53, wherein the preform and expanded preform are biaxially expanded, uniaxially expanded, radially expanded, or a combination thereof, or wherein the preform is expanded at a temperature from about 110° C. to about 135° C., or wherein the preform is expanded at a temperature from 140° C. to 170° C.

56. The method of claim 53, wherein the subjecting comprises calendering the lubricated UHMWPE polymer at a temperature below the melt temperature of UHMWPE polymer to form the preform.

57. The method of claim 53, comprising removing the lubricant from the preform prior to expanding.

58. The method of claim 53, wherein the UHMWPE polymer has a molecular weight from 2,000,000 g/mol to 12,000,000 g/mol, or wherein the UHMWPE membrane has a porosity greater than 60%, or wherein the UHMWPE membrane has a first endotherm associated with the UHMWPE polymer ranging from 139° C. to 143° C., or wherein the UHMWPE polymer includes from 0.001 mol % to 10 mol % of comonomer.
